(19) United States
(12) Patent Application Publication
(10) Pub. No.: US 2026/0300019 A1
(43) Pub. Date: Oct. 1, 2026

(54) DYNAMIC ADJUSTMENT OF RATE LIMITS FOR WORKLOADS RUNNING ON A STORAGE SYSTEM HAVING A PERFORMANCE PRIORITIZATION BUDGET

(71) Applicant: Dell Products L.P., Round Rock, TX (US)

(72) Inventor: Rivka Mayraz Matosevich, Zichron Ya'acov (IL)

(21) Appl. No.: 19/092,717

(22) Filed: Mar. 27, 2025

(51) Int. Cl. G06F 9/50; G06F 11/34

(52) U.S. Cl. CPC G06F 9/5038; G06F 9/5044; G06F 11/3433

(57) ABSTRACT

An apparatus comprises at least one processing device configured to determine a performance prioritization budget, to assign first and second rate limits for workloads running on the storage system, and to assign a third rate limit to each of a subset of the workloads, a sum of the third rate limits assigned to respective workloads of the subset being less than or equal to the performance prioritization budget. The at least one processing device is also configured to monitor performance, and to dynamically adjust a current rate limit for at least a given workload based at least in part on the monitored performance. If the given workload is in the subset, the current rate limit is dynamically adjusted between its assigned third and second rate limits. If the given workload is not in the subset, the current rate limit is dynamically adjusted between its assigned first and second rate limits.

### BACKGROUND

Information processing systems often include distributed arrangements of multiple nodes, also referred to herein as distributed processing systems. Such systems can include, for example, distributed storage systems comprising multiple storage nodes. These distributed storage systems are often dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. Data within the system is partitioned, striped, and replicated across the distributed storage nodes. For a storage administrator, the software-defined storage system provides a logical view of a given dynamic storage pool that can be expanded or contracted at ease, with simplicity, flexibility, and different performance characteristics. For applications running on a host device that utilizes the software-defined storage system, such a storage system provides a logical storage object view to allow a given application to store and access data, without the application being aware that the data is being dynamically distributed among different storage nodes potentially at different sites.

### SUMMARY

Illustrative embodiments of the present disclosure provide techniques for dynamic adjustment of rate limits for workloads running on a storage system having a performance prioritization budget.

In one embodiment, an apparatus comprises at least one processing device comprising a processor coupled to a memory. The at least one processing device is configured to determine, for a storage system, a performance prioritization budget, and to assign, for each of a plurality of workloads running on the storage system, a respective first rate limit and a respective second rate limit. The at least one processing device is also configured to assign, for each of at least a subset of the plurality of workloads running on the storage system, a respective third rate limit greater than the first rate limit assigned to that workload, wherein a sum of the third rate limits assigned to respective workloads of the subset is less than or equal to the determined performance prioritization budget for the storage system. The at least one processing device is further configured to monitor performance of the plurality of workloads running on the storage system, and to dynamically adjust a current rate limit for at least a given one of the plurality of workloads running on the storage system based at least in part on the monitored performance, wherein if the given workload is in the subset of the plurality of workloads the current rate limit for the given workload is dynamically adjusted between the third rate limit assigned to the given workload and the second rate limit assigned to the given workload, and wherein if the given workload is not in the subset of the plurality of workloads the current rate limit for the given workload is dynamically adjusted between the first rate limit assigned to the given workload and the second rate limit assigned to the given workload.

These and other illustrative embodiments include, without limitation, methods, apparatus, networks, systems and processor-readable storage media.

### BRIEF DESCRIPTION OF THE DRAWINGS

FIGS. 1A-1C are block diagrams of an information processing system comprising a storage system configured for dynamic adjustment of rate limits for workloads running on the storage system in accordance with a performance prioritization budget in an illustrative embodiment.

FIG. 2 is a flow diagram of an exemplary process for dynamic adjustment of rate limits for workloads running on a storage system having a performance prioritization budget in an illustrative embodiment.

FIG. 3 schematically illustrates an example framework of a node for implementing a compute, storage or management node which hosts logic for dynamic adjustment of rate limits for workloads running on a storage system having a performance prioritization budget processing for a storage system in an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

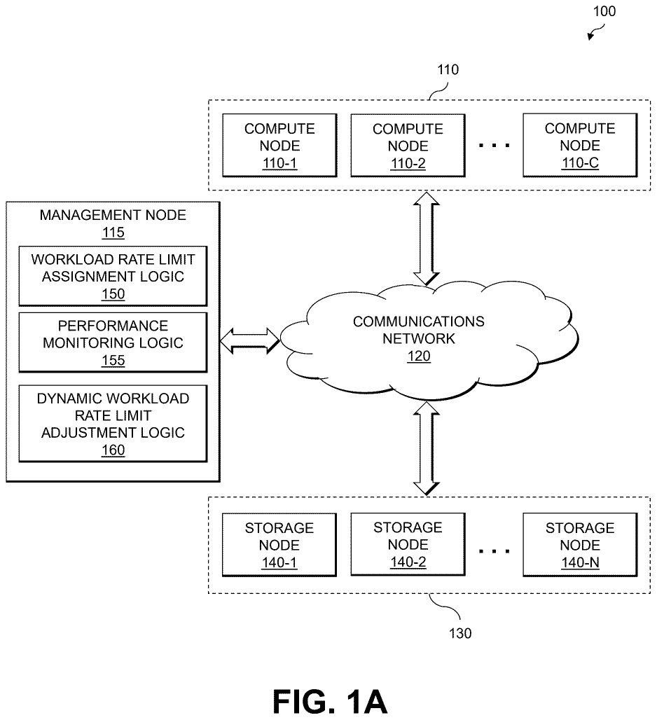

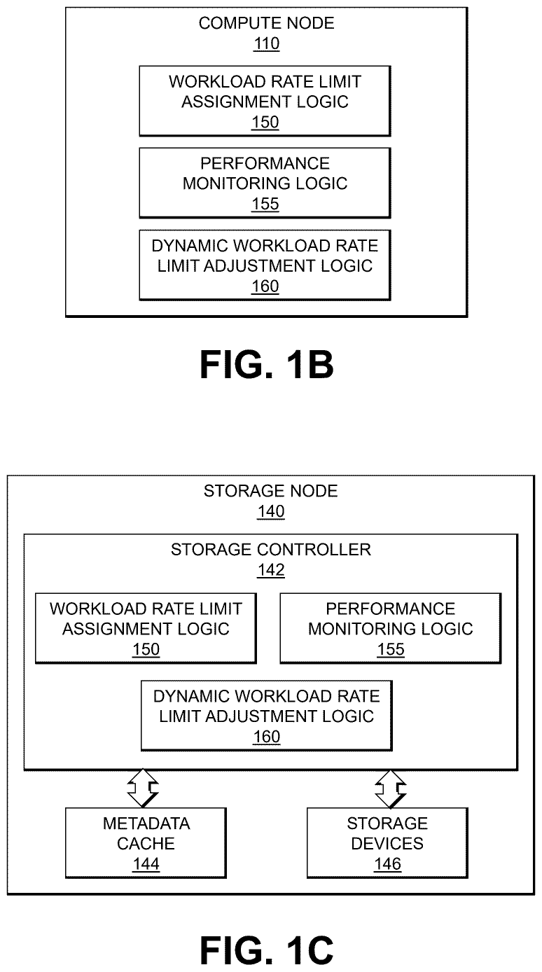

FIGS. 1A-1C schematically illustrate an information processing system 100 which is configured to implement functionality for dynamic adjustment of rate limits for workloads running on a storage system having a performance prioritization budget. More specifically, FIG. 1A schematically illustrates an information processing system 100 which comprises a plurality of compute nodes 110-1, 110-2, . . . , 110-C (collectively referred to as compute nodes 110, or each singularly referred to as a compute node 110), one or more management nodes 115 (which support a management layer of the system 100), a communications network 120, and a data storage system 130 (which supports a data storage layer of the system 100). The data storage system 130 comprises a plurality of storage nodes 140-1, 140-2, . . . , 140-N (collectively referred to as storage nodes 140, or each singularly referred to as a storage node 140). FIG. 1B schematically illustrates an exemplary framework of at least one or more of the compute nodes 110, and FIG. 1C schematically illustrates an exemplary framework of at least one or more of the storage nodes 140. In the context of the exemplary embodiments described herein, the compute nodes 110, the management nodes 115 and the data storage system 130 implements workload rate limit assignment logic 150, performance monitoring logic 155 and dynamic workload rate limit adjustment logic 160.

As shown in FIG. 1C, the storage node 140 comprises a storage controller 142, a metadata cache 144 and a plurality of storage devices 146. In general, the storage controller 142 implements data storage and management methods that are configured to divide the storage capacity of the storage devices 146 into storage pools and logical volumes. Storage controller 142 is further configured to implement the workload rate limit assignment logic 150, the performance monitoring logic 155 and the dynamic workload rate limit adjustment logic 160 in accordance with the disclosed embodiments. Various other examples are possible. It is to be noted that the storage controller 142 may include additional modules and other components typically found in conventional implementations of storage controllers and storage systems, although such additional modules and other components are omitted for clarity and simplicity of illustration.

In the embodiment of FIGS. 1A-1C, the workload rate limit assignment logic 150, the performance monitoring logic 155 and the dynamic workload rate limit adjustment logic 160 may be implemented at least in part within the one or more compute nodes 110 and/or the one or more management nodes 115, as well as in one or more of the storage nodes 140 of the data storage system 130. This may include implementing different portions of the functionality of the workload rate limit assignment logic 150, the performance monitoring logic 155 and the dynamic workload rate limit adjustment logic 160 in different ones of the compute nodes 110, the management nodes 115 and/or the storage nodes 140.

The compute nodes 110 illustratively comprise physical compute nodes and/or virtual compute nodes which process data and execute workloads. For example, the compute nodes 110 can include one or more servers (e.g., bare metal servers) and/or one or more virtual machines. In some embodiments, the compute nodes 110 comprise a cluster of physical servers or other types of computers of an enterprise computer system, cloud-based computing system or other arrangement of multiple compute nodes associated with respective users. In some embodiments, the compute nodes 110 include a cluster of virtual machines that execute on one or more physical servers.

The compute nodes 110 are configured to process data and execute tasks/workloads and perform computational work, either individually, or in a distributed manner, to thereby provide compute services such as execution of one or more applications on behalf of each of one or more users associated with respective ones of the compute nodes. Such applications illustratively issue input-output (IO) requests that are processed by a corresponding one of the storage nodes 140. The term “input-output” as used herein refers to at least one of input and output. For example, IO requests may comprise write requests and/or read requests directed to stored data of a given one of the storage nodes 140 of the data storage system 130.

The compute nodes 110 are configured to write data to and read data from the storage nodes 140 in accordance with applications executing on those compute nodes for system users. The compute nodes 110 communicate with the storage nodes 140 over the communications network 120. While the communications network 120 is generically depicted in FIG. 1A, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., Ethernet storage network), or various portions or combinations of these and other types of networks.

In this regard, the term “network” as used herein is therefore intended to be broadly construed so as to encompass a wide variety of different network arrangements, including combinations of multiple networks possibly of different types, which enable communication using, e.g., Transfer Control/Internet Protocol (TCP/IP) or other communication protocols such as Fibre Channel (FC), FC over Ethernet (FCoE), Internet Small Computer System Interface (iSCSI), Peripheral Component Interconnect express (PCIe), InfiniBand, Gigabit Ethernet, etc., to implement IO channels and support storage network connectivity. Numerous alternative networking arrangements are possible in a given embodiment, as will be appreciated by those skilled in the art.

The data storage system 130 may comprise any type of data storage system, or a combination of data storage systems, including, but not limited to, a storage area network (SAN) system, a network attached storage (NAS) system, a direct-attached storage (DAS) system, etc., as well as other types of data storage systems comprising software-defined storage, clustered or distributed virtual and/or physical infrastructure. The term “data storage system” as used herein should be broadly construed and not viewed as being limited to storage systems of any particular type or types. In some embodiments, the storage nodes 140 comprise storage server nodes having one or more processing devices each having a processor and a memory, possibly implementing virtual machines and/or containers, although numerous other configurations are possible. In some embodiments, one or more of the storage nodes 140 can additionally implement functionality of a compute node, and vice-versa. The term “storage node” as used herein is therefore intended to be broadly construed, and a storage system in some embodiments can be implemented using a combination of storage nodes and compute nodes.

In some embodiments, as schematically illustrated in FIG. 1C, the storage node 140 is a physical server node or storage appliance, wherein the storage devices 146 comprise DAS resources (internal and/or external storage resources) such as hard-disk drives (HDDs), solid-state drives (SSDs), Flash memory cards, or other types of non-volatile memory (NVM) devices such as non-volatile random access memory (NVRAM), phase-change RAM (PC-RAM) and magnetic RAM (MRAM). These and various combinations of multiple different types of storage devices 146 may be implemented in the storage node 140. In this regard, the term “storage device” as used herein is intended to be broadly construed, so as to encompass, for example, SSDs, HDDs, flash drives, hybrid drives or other types of storage media. The storage devices 146 are connected to the storage node 140 through any suitable host interface, e.g., a host bus adapter, using suitable protocols such as Advanced Technology Attachment (ATA), Serial ATA (SATA), External SATA (eSATA), Non-Volatile Memory Express (NVMe), NVMe Over Fabric (NVMe-oF), Small Computer System Interface (SCSI), Serial Attached SCSI (SAS), etc. In other embodiments, the storage node 140 can be network connected to one or more NAS nodes over a local area network. The metadata cache 144 may be implemented using memory resources.

The storage controller 142 is configured to manage the metadata cache 144 and the storage devices 146, and to control IO access to the metadata cache 144, the storage devices 146 and/or other storage resources (e.g., DAS or NAS resources) that are directly attached or network-connected to the storage node 140. In some embodiments, the storage controller 142 is a component (e.g., storage data server) of a software-defined storage (SDS) system which supports the virtualization of the storage devices 146 by separating the control and management software from the hardware architecture. More specifically, in a software-defined storage environment, the storage controller 142 comprises an SDS storage data server that is configured to abstract storage access services from the underlying storage hardware to thereby control and manage IO requests issued by the compute nodes 110, as well as to support networking and connectivity. In this instance, the storage controller 142 comprises a software layer that is hosted by the storage node 140 and deployed in the data path between the compute nodes 110 and the storage devices 146 of the storage node 140, and is configured to respond to data IO requests from the compute nodes 110 by accessing the storage devices 146 to store/retrieve data to/from the storage devices 146 based on the IO requests. Processing of the data IO requests may utilize various metadata, which may be stored in the metadata cache 144 (e.g., for faster access) or in the storage devices 146 themselves.

In a software-defined storage environment, the storage controller 142 is configured to provision, orchestrate and manage the local storage resources (e.g., the storage devices 146) of the storage node 140. For example, the storage controller 142 implements methods that are configured to create and manage storage pools (e.g., virtual pools of block storage) by aggregating capacity from the storage devices 146. The storage controller 142 can divide a storage pool into one or more volumes and expose the volumes to the compute nodes 110 as virtual block devices. For example, a virtual block device can correspond to a volume of a storage pool. Each virtual block device comprises any number of actual physical storage devices, wherein each block device is preferably homogenous in terms of the type of storage devices that make up the block device (e.g., a block device only includes either HDD devices or SSD devices, etc.).

In the software-defined storage environment, each of the storage nodes 140 in FIG. 1A can run an instance of the storage controller 142 to convert the respective local storage resources (e.g., DAS storage devices and/or NAS storage devices) of the storage nodes 140 into local block storage. Each instance of the storage controller 142 contributes some or all of its local block storage (HDDs, SSDs, PCIe, NVMe and flash cards) to an aggregated pool of storage of a storage server node cluster (e.g., cluster of storage nodes 140) to implement a server-based storage area network (SAN) (e.g., virtual SAN). In this configuration, each storage node 140 is part of a loosely coupled server cluster which enables “scale-out” of the software-defined storage environment, wherein each instance of the storage controller 142 that runs on a respective one of the storage nodes 140 contributes its local storage space to an aggregated virtual pool of block storage with varying performance tiers (e.g., HDD, SSD, etc.) within a virtual SAN.

In some embodiments, in addition to the storage controllers 142 operating as SDS storage data servers to create and expose volumes of a storage layer, the software-defined storage environment comprises other components such as (i) SDS data clients that consume the storage layer and (ii) SDS metadata managers that coordinate the storage layer, which are not specifically shown in FIG. 1A. More specifically, on the client-side (e.g., compute nodes 110), an SDS data client (SDC) is a lightweight block device driver that is deployed on each server node that consumes the shared block storage volumes exposed by the storage controllers 142. In particular, the SDCs run on the same servers as the compute nodes 110 which require access to the block devices that are exposed and managed by the storage controllers 142 of the storage nodes 140. The SDC exposes block devices representing the virtual storage volumes that are currently mapped to that host. In particular, the SDC serves as a block driver for a client (server), wherein the SDC intercepts IO requests, and utilizes the intercepted IO request to access the block storage that is managed by the storage controllers 142. The SDC provides the operating system or hypervisor (which runs the SDC) access to the logical block devices (e.g., volumes).

The SDCs have knowledge of which SDS control systems (e.g., which instances of the storage controller 142) hold its block data, so multipathing can be accomplished natively through the SDCs. In particular, each SDC knows how to direct an IO request to the relevant destination SDS storage data server (e.g., storage controller 142). In this regard, there is no central point of routing, and each SDC performs its own routing independent from any other SDC. This implementation prevents unnecessary network traffic and redundant SDS resource usage. Each SDC maintains peer-to-peer connections to every storage controller 142 that manages the storage pool. A given SDC can communicate over multiple pathways to all of the storage nodes 140 which store data that is associated with a given IO request. This multi-point peer-to-peer fashion allows the SDS to read and write data to and from all points simultaneously, eliminating bottlenecks and quickly routing around failed paths.

The management nodes 115 in FIG. 1A implement a management layer that is configured to manage and configure the storage environment of the system 100. In some embodiments, the management nodes 115 comprise the SDS metadata manager components, wherein the management nodes 115 comprise a tightly-coupled cluster of nodes that are configured to supervise the operations of the storage cluster and manage storage cluster configurations. The SDS metadata managers operate outside of the data path and provide the relevant information to the SDS clients and storage servers to allow such components to control data path operations. The SDS metadata managers are configured to manage the mapping of SDC data clients to the SDS data storage servers. The SDS metadata managers manage various types of metadata that are required for system operation of the SDS environment such as configuration changes, managing the SDS data clients and data servers, device mapping, values, snapshots, system capacity including device allocations and/or release of capacity, RAID protection, recovery from errors and failures, and system rebuild tasks including rebalancing.

While FIG. 1A shows an exemplary embodiment of a two-layer deployment in which the compute nodes 110 are separate from the storage nodes 140 and connected by the communications network 120, in other embodiments, a converged infrastructure (e.g., hyperconverged infrastructure) can be implemented to consolidate the compute nodes 110, storage nodes 140, and communications network 120 together in an engineered system. For example, in a hyperconverged deployment, a single-layer deployment is implemented in which the storage data clients and storage data servers run on the same nodes (e.g., each node deploys a storage data client and storage data servers) such that each node is a data storage consumer and a data storage supplier. In other embodiments, the system of FIG. 1A can be implemented with a combination of a single-layer and two-layer deployment.

Regardless of the specific implementation of the storage environment, as noted above, various modules of the storage controller 142 of FIG. 1B collectively provide data storage and management methods that are configured to perform various functions as follows. In particular, a storage virtualization and management services module may implement any suitable logical volume management (LVM) system which is configured to create and manage local storage volumes by aggregating the storage devices 146 into one or more virtual storage pools that are thin-provisioned for maximum capacity, and logically dividing each storage pool into one or more storage volumes that are exposed as block devices (e.g., raw logical unit numbers (LUNs)) to the compute nodes 110 to store data. In some embodiments, the storage devices 146 are configured as block storage devices where raw volumes of storage are created and each block can be controlled as, e.g., an individual disk drive by the storage controller 142. Each block can be individually formatted with a same or different file system as required for the given data storage system application.

In some embodiments, the storage pools are primarily utilized to group storage devices based on device types and performance. For example, SSDs are grouped into SSD pools, and HDDs are grouped into HDD pools. Furthermore, in some embodiments, the storage virtualization and management services module implements methods to support various data storage management services such as data protection, data migration, data deduplication, replication, thin provisioning, snapshots, data backups, etc.

Storage systems, such as the data storage system 130 of system 100, may be required to provide both high performance and a rich set of advanced data service features for end-users thereof (e.g., users operating compute nodes 110, applications running on compute nodes 110). Performance may refer to latency, or other metrics such as IO operations per second (IOPS), bandwidth, etc. Advanced data service features may refer to data service features of storage systems including, but not limited to, services for data resiliency, thin provisioning, data reduction, space efficient snapshots, etc. Fulfilling both performance and advanced data service feature requirements can represent a significant design challenge for storage systems. This may be due to different advanced data service features consuming significant resources and processing time. Such challenges may be even greater in software-defined storage systems in which custom hardware is not available for boosting performance.

Device tiering may be used in some storage systems, such as in storage systems that contain some relatively “fast” and expensive storage devices and some relatively “slow” and less expensive storage devices. In device tiering, the “fast” devices may be used when performance is the primary requirement, where the “slow” and less expensive devices may be used when capacity is the primary requirement. Such device tiering may also use cloud storage as the “slow” device tier. Some storage systems may also or alternately separate devices offering the same performance level to gain performance isolation between different sets of storage volumes. For example, the storage systems may separate the “fast” devices into different groups to gain performance isolation between storage volumes on such different groups of the “fast” devices.

Storage systems, such as the data storage system 130 (e.g., which may be implemented as a NAS system), may be designed to serve multiple hosts and workloads. Before attaching a host or workload to the data storage system 130, a customer or user may assess the data storage system 130's ability to support the new and any existing workloads with acceptable performance. However, changes in workloads, peaks and component failures can impact the performance experienced by applications and can result in unacceptable performance in critical applications. Storage Quality of Service (QoS) is one strategy to ensure the performance of critical applications. Storage QoS typically enforces limits on non-critical workloads to ensure that sufficient system resources are available for high priority workloads. Relying on a worst-case scenario to set QoS parameters can provide a safe approach, but it is often overly conservative, resulting in underutilization of the storage system's capabilities when the worst-case conditions do not occur. Conversely, using an average-case scenario for setting QoS parameters can improve system utilization but may lead to performance issues for critical workloads if actual conditions are worse than expected (e.g., worse than the average-case scenario). Regardless of whether a worst-case or average-case scenario is used for QoS settings, rate-limiting QoS does not guarantee consistent performance for critical workloads.

Block storage QoS approaches are rate limiting, and work by capping the IOs of non-critical applications or workloads to a configured maximum limit, thereby freeing up system resources for critical applications or workloads. However, to achieve guaranteed performance for specific workloads under changing conditions, users must set relatively low limits for non-critical workloads. In other words, providing guaranteed performance with conventional QoS methods leads to underutilization of system resources under normal conditions. Illustrative embodiments provide technical solutions that enable full or improved utilization of system resources (e.g., of data storage system 130), and provides guaranteed performance for critical workloads despite reasonable changes, such as peaks, workload variations and component failures.

An end-user may assign a performance guarantee (e.g., a specified IOPS metric, a specified IO throughput and/or IO latency, etc.) to one or more critical workloads, also referred to as “guaranteed” workloads. The total guaranteed performance cannot exceed a performance prioritization budget of the data storage system 130, which may be calculated as a fraction of the expected performance of the data storage system 130. The data storage system 130 monitors the performance of the critical or guaranteed workloads (e.g., those assigned a performance guarantee), and dynamically adjusts the rate limits accordingly. In some embodiments, the rate limits for only the non-critical or non-guaranteed workloads (e.g., those not assigned a performance guarantee) are adjusted. In other embodiments, the rate limits for all workloads (e.g., both those with and without assigned performance guarantees) are adjusted. If the performance of the critical or guaranteed workloads falls below an acceptable performance threshold, the rate limits for workloads (e.g., the non-critical or non-guaranteed workloads, and potentially one or more of the critical or guaranteed workloads) are reduced. Conversely, if the performance of the critical or guaranteed workloads meets the desired standards, the rate limits for workloads (e.g., the non-critical or non-guaranteed workloads, and potentially one or more of the critical or guaranteed workloads) are increased to optimize or improve utilization of the resources of the data storage system 130. The rate limits for the non-critical or non-guaranteed workloads may have a minimal rate below which they are never set, to ensure that the non-critical or non-guaranteed workloads are not starved.

System performance, IOPS, throughput and latency depend on numerous factors, and can vary significantly for a given configuration of a storage system such as the data storage system 130. Some contributors to this variance include: the use of advanced features such as snapshots and replication; system component failures; the nature of workloads (e.g., small random IOs versus large sequential IOs); etc. Therefore, calculating the actual available performance for a particular storage system (e.g., the data storage system 130) requires considering many dynamic variables. As such, some embodiments use an average-case evaluation of the system's performance as the basis for estimating available performance. To account for unknown variables that may impact actual system performance, the performance budget that can be committed will be a fraction of this average-case evaluation (e.g., 30%). The uncommitted portion of the system performance will serve as a buffer to absorb any reductions in overall system performance and changes in workload characteristics. Additionally, this buffer will ensure that workloads without performance commitments are not deprived of resources. Estimating the system's “average-case” performance may be based on performance tests of similar storage systems, using simulated workloads, combinations thereof, etc. Other methods, such as the use of digital twins, can also be used.

When a workload includes dependent IOs, the experienced IO latency may limit the total generated load. This situation can create a false impression that the system has met its commitments, when in reality the low workload is due to the high latency. Therefore, the IOPS or throughput guarantee, in some embodiments, is tied to an average latency expectation for those IOs. In such embodiments, a workload meets its “guaranteed” performance when the throughput or IOPS limits are met, or if the average latency meets the expected average latency. The average latency expected for all committed workloads can be set to a default value based on the system configuration. This value, however, may be adjusted by an end-user, a storage system administrator, support, etc., to align with the desired IO latency and its impact on non-committed or non-guaranteed workloads.

Various parameters may be used for implementing performance guarantees for critical or guaranteed workloads. The expected average performance is a system-wide parameter defining the expected IO latency for all critical or guaranteed workloads. In some embodiments, as will be described in further detail below, expected average performance may be defined on a per-workload basis.

Each workload in the system has a mandatory maximal rate limit and an optional guaranteed rate limit. The maximal allowed rate, denoted MARᵢ (e.g., in terms of IOPS or throughput), is the maximal rate limit for workload i. This may be similar to the rate limit used for traditional storage QoS. A workload maximal allowed rate has a default value, which may be set to a very high rate representing the whole system performance potential. The minimal rate limit, denoted MLᵢ, is the minimal rate limit to which the algorithm may reduce the currently allowed rate, denoted CARᵢ, for a workload i. Setting the minimal rate limit guarantees that non-critical or non-guaranteed workloads are not starved. It should be noted that the minimal rate limit may be set as a system-wide parameter, or may be configurable per workload. The CARᵢ is the rate currently allowed for a workload. The system ensures that the IO rate for workload i does not exceed CARᵢ. The system dynamically adjusts CARᵢ between MLᵢ and MARᵢ. A guaranteed rate, denoted GRᵢ, is the guaranteed performance for workload i, which may be measured in IOPS, throughput, etc. By default, GRᵢ is set to 0. The total performance guarantee budget that may be assigned to workloads is in units of IOPS, throughput, etc. The end-user may select the unit that they prefer, and must use the same unit when allocating guarantees to workloads.

The system restricts IO rates for workloads using the current allowed rate as the limit, where CARᵢ for workload i is dynamically adjusted to ensure the committed performance is delivered, the system performance is utilized, and non-committed or non-guaranteed workloads are served fairly. The system monitors the average latency achieved by the committed workloads. Periodically, the measured average latency over a moving window is compared with the expected average latency. If the measured average latency crosses a threshold above or below the expected average latency, a dynamic change in the current allowed rate for one or more workloads is triggered. If the measured average latency is too high, the storage system adjusts down the current allowed rate for all workloads, with the following limitations: CARᵢ≥MLᵢ (e.g., the current allowed rate is never below the minimal limit) and CARᵢ≥GRᵢ (e.g., the current allowed rate is never below the guaranteed limit for guaranteed workloads). If the average latency is lower than or equal to the expected average latency, the system may adjust up the maximal allowed rate for all workloads, with the following limitation: CARᵢ≤MARᵢ (e.g., the current allowed rate is never greater than the maximal limit). The adjustments to the current allowed rates for workloads may be made in small changes, to avoid creating large impacts on their performance. Over a series of such small changes, the performance can be adjusted to ensure the performance of the guaranteed workloads.

Under extreme conditions, a system may be unable to honor the guarantees. This can result from multiple failures, unexpected peak workloads, or an overly optimistic setting of the expected average performance. However, this should not happen if the guarantee budget, the average expected latency, and the workloads assigned to the system are configured realistically.

In some cases, users may add many non-guaranteed workloads to a system, where each of the non-guaranteed workloads has a minimal limit (MLᵢ) that the system will honor. The accumulation of these minimal limits may minimize the dynamic changes to the currently allowed rates (CARᵢ) for workloads, and cause the system to miss the guarantee for one or more guaranteed workloads. To overcome this limitation, a budget can be defined for the minimal limit of non-guaranteed workloads similar to the guarantee budget.

In some cases, workloads may have drastically different expected latency (e.g., when one workload is synchronously replicated and another is not). In such cases, the user may want the expected average latency to be defined per workload, or for a set of workloads. If this is done, some latency thresholds may be broken while others are kept. In this case, the dynamic adjustment of the current allowed rate limits is triggered by one or more of the following: a single average latency exceeding the threshold triggers lowering current allowed rate values; and/or when all average latencies are below the lower threshold, the current allowed rate values are adjusted up.

If some workloads are left with a default maximum allowed rate, it is possible that small adjustments in the MARᵢ values may initially take a long time to achieve the guaranteed performance. This can be overcome by the first change (e.g., from an “infinite” or arbitrarily high default value) being more dramatic than subsequent changes.

The technical solutions, in some embodiments, provide functionality for configuring a performance prioritization budget that is based at least in part on a hardware and/or software configuration of a system (e.g., the data storage system 130), where the performance prioritization budget is a portion of the system's baseline or average performance. The performance prioritization budget may also be referred to as a performance “guarantee” budget, and characterizes an amount of performance which may be allocated to specific workloads (e.g., critical or “guaranteed” workloads that are associated with performance guarantees). It should be appreciated that a performance “guarantee” does not actually require that a particular performance metric is achieved, though the system makes an effort to provide the guaranteed performance to workloads having performance guarantee. The technical solutions further enable the configuration of performance guarantees (e.g., in terms of IOPS, throughput, etc.) for specific workloads. Providing the guaranteed performance under varying conditions is achieved through dynamic adjustment of the IOPS or throughput limits across all workloads (e.g., including both guaranteed and non-guaranteed workloads). Further, the technical solutions ensure that non-guaranteed workloads are not starved, allowing them to receive their fair share of the system performance.

Illustrative embodiments provide functionality for optimizing or improving performance of storage systems (e.g., the data storage system 130), through dynamic adjustment of rate limits for workloads running on a storage system having a performance prioritization budget utilizing the workload rate limit assignment logic 150, the performance monitoring logic 155 and the dynamic workload rate limit adjustment logic 160. The workload rate limit assignment logic 150 is configured to assign rate limits to workloads running on the data storage system 130, where the rate limits include a first rate limit (e.g., a minimal rate), a second rate limit (e.g., a maximum allowed rate), and an optional third rate limit (e.g., a guaranteed rate). The performance monitoring logic 155 is configured to monitor performance of the workloads running on the data storage system 130. The dynamic workload rate limit adjustment logic 160 is configured to adjust current allowed rate limits for the workloads running on the data storage system 130 based on the monitored performance, where if a given workload has a non-zero assigned value for the third rate limit, its current allowed rate is dynamically adjust between its third and second rate limit and if the given workload has no assigned third rate limit (or an assigned third rate limit of zero), its current allowed rate is dynamically adjusted between its first and second rate limit.

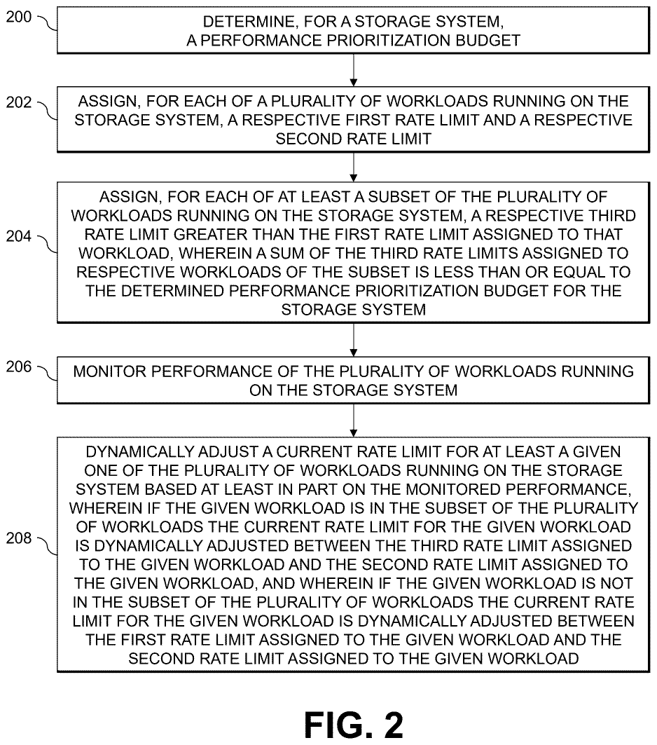

FIG. 2 is a flow diagram of a process for dynamic adjustment of rate limits for workloads running on a storage system having a performance prioritization budget according to an exemplary embodiment of the disclosure. The process as shown in FIG. 2 includes steps 200 through 208. For purposes of illustration, the process flow of FIG. 2 will be discussed in the context of the information processing system 100 shown in FIGS. 1A-1C.

At step 200, a performance prioritization budget is determined for a storage system (e.g., the data storage system 130). The performance prioritization budget may be determined as a specified portion of an average performance of the storage system.

At step 202, a respective first rate limit (e.g., a minimal rate) and a respective second rate limit (e.g., a maximal allowed rate) are assigned for each of a plurality of workloads running on the storage system.

At step 204, a respective third rate limit (e.g., a “guaranteed” rate) is assigned for each of at least a subset of the plurality of workloads running on the storage system, where a sum of the third rate limits is less than or equal to the determined performance prioritization budget for the storage system.

In some embodiments, each of the plurality of workloads is assigned a same value for the first rate limit. In other embodiments, different ones of the plurality of workloads are assigned different values for the first rate limit. The first rate limit, the second rate limit and the third rate limit may specify IOPS values, IO throughput values, etc.

At step 206, performance of the plurality of workloads running on the storage system is monitored.

At step 208, a current rate limit for at least a given one of the plurality of workloads running on the storage system is dynamically adjusted based at least in part on the monitored performance. If the given workload is in the subset of the plurality of workloads the current rate limit for the given workload is dynamically adjusted between the third rate limit assigned to the given workload and the second rate limit assigned to the given workload. If the given workload is not in the subset of the plurality of workloads the current rate limit for the given workload is dynamically adjusted between the first rate limit assigned to the given workload and the second rate limit assigned to the given workload.

The dynamic adjustment of the current rate limit for the given workload may be triggered in response to detecting one or more designated performance conditions. Monitoring the performance of the plurality of workloads running on the storage system may comprise determining an average latency for the plurality of workloads running on the storage system, wherein detecting the one or more designated performance conditions comprises a comparison of the determined average latency and an expected average latency, the expected average latency is determined based at least in part on a hardware and software configuration of the storage system. The one or more designated performance conditions may comprise detecting that the determined average latency for the plurality of workloads running on the storage system is less than an expected average latency for the storage system, and dynamically adjusting the current rate limit for the given workload may comprise increasing the current rate limit for the given workload. The one or more designated performance conditions may comprise detecting that the determined average latency achieved by the plurality of workloads running on the storage system is greater than an expected average latency for the storage system, and dynamically adjusting the current rate limit for the given workload may comprise reducing the current rate limit for the given workload.

In some embodiments, the determined average latency and the expected average latency are calculated on a per-workload basis. In such embodiments, the one or more designated performance conditions may comprise detecting that the determined average latency for at least one of the plurality of workloads exceeds the expected average latency for the at least one of the plurality of workloads, and dynamically adjusting the current rate limit for the given workload may comprise decreasing the current rate limit for the given workload. The one or more designated performance conditions may comprise detecting that the determined average latency for each of plurality of workloads is less than the expected average latency for each of the plurality of workloads, and dynamically adjusting the current rate limit for the given workload may comprise increasing the current rate limit for the given workload.

The particular processing operations and other system functionality described above in conjunction with the flow diagram of FIG. 2 are presented by way of illustrative examples only, and should not be construed as limiting the scope of the disclosure in any way. Alternative embodiments can use other types of processing operations for implementing functionality for connection establishment across failure domains in component layers of a target system. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

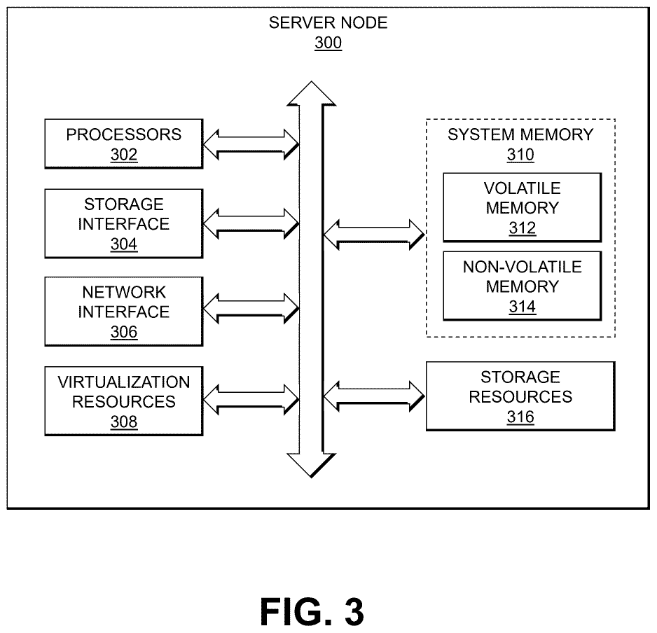

FIG. 3 schematically illustrates a framework of a system node 300 (e.g., one or more the compute nodes 110, the management node 115 and/or the storage nodes 140 in the information processing system 100 of FIGS. 1A-1C), which can be implemented for hosting logic for dynamic adjustment of rate limits for workloads running on a storage system having a performance prioritization budget (e.g., the workload rate limit assignment logic 150, the performance monitoring logic 155 and the dynamic workload rate limit adjustment logic 160). The system node 300 comprises processors 302, storage interface circuitry 304, network interface circuitry 306, virtualization resources 308, system memory 310, and storage resources 316. The system memory 310 comprises volatile memory 312 and non-volatile memory 314.

The processors 302 comprise one or more types of hardware processors that are configured to process program instructions and data to execute a native operating system (OS) and applications that run on the system node 300. For example, the processors 302 may comprise one or more CPUs, microprocessors, microcontrollers, application specific integrated circuits (ASICs), field programmable gate arrays (FPGAs), and other types of processors, as well as portions or combinations of such processors. The term “processor” as used herein is intended to be broadly construed so as to include any type of processor that performs processing functions based on software, hardware, firmware, etc. For example, a “processor” is broadly construed so as to encompass all types of hardware processors including, for example, (i) general purpose processors which comprise “performance cores” (e.g., low latency cores), and (ii) workload-optimized processors, which comprise any possible combination of multiple “throughput cores” and/or multiple hardware-based accelerators. Examples of workload-optimized processors include, for example, graphics processing units (GPUs), digital signal processors (DSPs), system-on-chip (SoC), tensor processing units (TPUs), image processing units (IPUs), deep learning accelerators (DLAs), artificial intelligence (AI) accelerators, and other types of specialized processors or coprocessors that are configured to execute one or more fixed functions.

The storage interface circuitry 304 enables the processors 302 to interface and communicate with the system memory 310, the storage resources 316, and other local storage and off-infrastructure storage media, using one or more standard communication and/or storage control protocols to read data from or write data to volatile and non-volatile memory/storage devices. Such protocols include, but are not limited to, NVMe, peripheral component interconnect express (PCIe), Parallel ATA (PATA), SATA, SAS, Fibre Channel, etc. The network interface circuitry 306 enables the system node 300 to interface and communicate with a network and other system components. The network interface circuitry 306 comprises network controllers such as network cards and resources (e.g., network interface controllers (NICs) including SmartNICs, RDMA-enabled NICs, etc., Host Bus Adapter (HBA) cards, Host Channel Adapter (HCA) cards, IO adaptors, converged Ethernet adaptors, etc.) to support communication protocols and interfaces including, but not limited to, PCIe, DMA and RDMA data transfer protocols, etc.

The virtualization resources 308 can be instantiated to execute one or more services or functions which are hosted by the system node 300. For example, the virtualization resources 308 can be configured to implement the various modules and functionalities the management node 115 as shown in FIG. 1A, the compute nodes 110 as shown in FIG. 1B, or the storage controller 142 as shown in FIG. 1C as discussed herein. In some embodiments, the virtualization resources 308 comprise virtual machines that are implemented using a hypervisor platform which executes on the system node 300, wherein one or more virtual machines can be instantiated to execute functions of the system node 300. As is known in the art, virtual machines are logical processing elements that may be instantiated on one or more physical processing elements (e.g., servers, computers, or other processing devices). That is, a “virtual machine” generally refers to a software implementation of a machine (i.e., a computer) that executes programs in a manner similar to that of a physical machine. Thus, different virtual machines can run different operating systems and multiple applications on the same physical computer.

A hypervisor is an example of what is more generally referred to as “virtualization infrastructure.” The hypervisor runs on physical infrastructure, e.g., CPUs and/or storage devices, of the system node 300, and emulates the CPUs, memory, hard disk, network and other hardware resources of the host system, enabling multiple virtual machines to share the resources. The hypervisor can emulate multiple virtual hardware platforms that are isolated from each other, allowing virtual machines to run, e.g., Linux and Windows Server operating systems on the same underlying physical host. The underlying physical infrastructure may comprise one or more commercially available distributed processing platforms which are suitable for the target application.

In other embodiments, the virtualization resources 308 comprise containers such as Docker containers or other types of Linux containers (LXCs). As is known in the art, in a container-based application framework, each application container comprises a separate application and associated dependencies and other components to provide a complete filesystem, but shares the kernel functions of a host operating system with the other application containers. Each application container executes as an isolated process in user space of a host operating system. In particular, a container system utilizes an underlying operating system that provides the basic services to all containerized applications using virtual-memory support for isolation. One or more containers can be instantiated to execute one or more applications or functions of the system node 300 as well as execute one or more of the various modules and functionalities of the management node 115, the compute nodes 110 or the storage controllers 142 as discussed herein. In yet other embodiments, containers may be used in combination with other virtualization infrastructure such as virtual machines implemented using a hypervisor, such as where Docker containers or other types of LXCs are configured to run on virtual machines in a multi-tenant environment.

In some embodiments, the various components, systems, and modules of the management nodes 115, the compute nodes 110 and/or the storage controllers 142 comprise program code that is loaded into the system memory 310 (e.g., volatile memory 312), and executed by the processors 302 to perform respective functions as described herein. In this regard, the system memory 310, the storage resources 316, and other memory or storage resources as described herein, which have program code and data tangibly embodied thereon, are examples of what is more generally referred to herein as “processor-readable storage media” that store executable program code of one or more software programs. Articles of manufacture comprising such processor-readable storage media are considered embodiments of the disclosure. An article of manufacture may comprise, for example, a storage device such as a storage disk, a storage array or an integrated circuit containing memory. The term “article of manufacture” as used herein should be understood to exclude transitory, propagating signals.

The system memory 310 comprises various types of memory such as volatile RAM, NVRAM, or other types of memory, in any combination. The volatile memory 312 may be a dynamic random-access memory (DRAM) (e.g., DRAM DIMM (Dual In-line Memory Module)), or other forms of volatile RAM. The non-volatile memory 314 may comprise one or more of NAND Flash storage devices, SSD devices, or other types of next generation non-volatile memory (NGNVM) devices. The system memory 310 can be implemented using a hierarchical memory tier structure wherein the volatile memory 312 is configured as the highest-level memory tier, and the non-volatile memory 314 (and other additional non-volatile memory devices which comprise storage-class memory) is configured as a lower level memory tier which is utilized as a high-speed load/store non-volatile memory device on a processor memory bus (e.g., data is accessed with loads and stores, instead of with IO reads and writes). The term “memory” or “system memory” as used herein refers to volatile and/or non-volatile memory which is utilized to store application program instructions that are read and processed by the processors 302 to execute a native operating system and one or more applications or processes hosted by the system node 300, and to temporarily store data that is utilized and/or generated by the native OS and application programs and processes running on the system node 300. The storage resources 316 can include one or more HDDs, SSD storage devices, etc.

It should again be emphasized that the above-described embodiments are presented for purposes of illustration only. Many variations and other alternative embodiments may be used. For example, the disclosed techniques are applicable to a wide variety of other types of information processing systems, storage systems, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine, for a storage system, a performance prioritization budget;
to assign, for each of a plurality of workloads running on the storage system, a respective first rate limit and a respective second rate limit;
to assign, for each of at least a subset of the plurality of workloads running on the storage system, a respective third rate limit greater than the first rate limit assigned to that workload, wherein a sum of the third rate limits assigned to respective workloads of the subset is less than or equal to the determined performance prioritization budget for the storage system;
to monitor performance of the plurality of workloads running on the storage system; and
to dynamically adjust a current rate limit for at least a given one of the plurality of workloads running on the storage system based at least in part on the monitored performance, wherein if the given workload is in the subset of the plurality of workloads the current rate limit for the given workload is dynamically adjusted between the third rate limit assigned to the given workload and the second rate limit assigned to the given workload, and wherein if the given workload is not in the subset of the plurality of workloads the current rate limit for the given workload is dynamically adjusted between the first rate limit assigned to the given workload and the second rate limit assigned to the given workload.

2. The apparatus of claim 1 wherein the performance prioritization budget is determined as a specified portion of an average performance of the storage system.

3. The apparatus of claim 1 wherein each of the plurality of workloads is assigned a same value for the first rate limit.

4. The apparatus of claim 1 wherein different ones of the plurality of workloads are assigned different values for the first rate limit.

5. The apparatus of claim 1 wherein the first rate limit, the second rate limit and the third rate limit for the given workload specify respective different input-output operations per second values.

6. The apparatus of claim 1 wherein the first rate limit, the second rate limit and the third rate limit for the given workload specify respective different input-output throughput values.

7. The apparatus of claim 1 wherein the dynamic adjustment of the current rate limit for the given workload is triggered in response to detecting one or more designated performance conditions.

8. The apparatus of claim 7 wherein monitoring the performance of the plurality of workloads running on the storage system comprises determining an average latency achieved for the plurality of workloads running on the storage system, and wherein detecting the one or more designated performance conditions is based at least in part on a comparison of the determined average latency and an expected average latency.

9. The apparatus of claim 8 wherein the expected average latency is determined based at least in part on a hardware and software configuration of the storage system.

10. The apparatus of claim 8 wherein the one or more designated performance conditions comprises detecting that the determined average latency for the plurality of workloads running on the storage system is less than the expected average latency for the storage system, and wherein dynamically adjusting the current rate limit for the given workload comprises increasing the current rate limit for the given workload.

11. The apparatus of claim 8 wherein the one or more designated performance conditions comprises detecting that the determined average latency achieved by the plurality of workloads running on the storage system is greater than the expected average latency for the storage system, and wherein dynamically adjusting the current rate limit for the given workload comprises reducing the current rate limit for the given workload.

12. The apparatus of claim 8 wherein the determined average latency and the expected average latency are calculated on a per-workload basis.

13. The apparatus of claim 12 wherein the one or more designated performance conditions comprises detecting that the determined average latency for at least one of the plurality of workloads exceeds the expected average latency for said at least one of the plurality of workloads, and wherein dynamically adjusting the current rate limit for the given workload comprises decreasing the current rate limit for the given workload.

14. The apparatus of claim 12 wherein the one or more designated performance conditions comprises detecting that the determined average latency for each of plurality of workloads is less than the expected average latency for each of the plurality of workloads, and wherein dynamically adjusting the current rate limit for the given workload comprises increasing the current rate limit for the given workload.

15. A computer program product comprising a non-transitory processor-readable storage medium having stored therein program code of one or more software programs, wherein the program code when executed by at least one processing device causes the at least one processing device:
to determine, for a storage system, a performance prioritization budget;
to assign, for each of a plurality of workloads running on the storage system, a respective first rate limit and a respective second rate limit;
to assign, for each of at least a subset of the plurality of workloads running on the storage system, a respective third rate limit greater than the first rate limit assigned to that workload, wherein a sum of the third rate limits assigned to respective workloads of the subset is less than or equal to the determined performance prioritization budget for the storage system;
to monitor performance of the plurality of workloads running on the storage system; and
to dynamically adjust a current rate limit for at least a given one of the plurality of workloads running on the storage system based at least in part on the monitored performance, wherein if the given workload is in the subset of the plurality of workloads the current rate limit for the given workload is dynamically adjusted between the third rate limit assigned to the given workload and the second rate limit assigned to the given workload, and wherein if the given workload is not in the subset of the plurality of workloads the current rate limit for the given workload is dynamically adjusted between the first rate limit assigned to the given workload and the second rate limit assigned to the given workload.

16. The computer program product of claim 15 wherein the dynamic adjustment of the current rate limit for the given workload is triggered in response to detecting one or more designated performance conditions.

17. The computer program product of claim 16 wherein monitoring the performance of the plurality of workloads running on the storage system comprises determining an average latency achieved for the plurality of workloads running on the storage system, and wherein detecting the one or more designated performance conditions is based at least in part on a comparison of the determined average latency and an expected average latency.

18. A method comprising:
determining, for a storage system, a performance prioritization budget;
assigning, for each of a plurality of workloads running on the storage system, a respective first rate limit and a respective second rate limit;
assigning, for each of at least a subset of the plurality of workloads running on the storage system, a respective third rate limit greater than the first rate limit assigned to that workload, wherein a sum of the third rate limits assigned to respective workloads of the subset is less than or equal to the determined performance prioritization budget for the storage system;
monitoring performance of the plurality of workloads running on the storage system; and
dynamically adjusting a current rate limit for at least a given one of the plurality of workloads running on the storage system based at least in part on the monitored performance, wherein if the given workload is in the subset of the plurality of workloads the current rate limit for the given workload is dynamically adjusted between the third rate limit assigned to the given workload and the second rate limit assigned to the given workload, and wherein if the given workload is not in the subset of the plurality of workloads the current rate limit for the given workload is dynamically adjusted between the first rate limit assigned to the given workload and the second rate limit assigned to the given workload;
wherein the method is performed by at least one processing device comprising a processor coupled to a memory.

19. The method of claim 18 wherein the dynamic adjustment of the current rate limit for the given workload is triggered in response to detecting one or more designated performance conditions.

20. The method of claim 19 wherein monitoring the performance of the plurality of workloads running on the storage system comprises determining an average latency achieved for the plurality of workloads running on the storage system, and wherein detecting the one or more designated performance conditions is based at least in part on a comparison of the determined average latency and an expected average latency.
